(19) United States
(12) Patent Application Publication
(10) Pub. No.: US 2002/0010989 A1
(43) Pub. Date: Jan. 31, 2002

(54) Cinerary container

(76) Inventor: Yoshie Suda, Kawaguchishi (JP)

Correspondence Address: FRISHAUF, HOLTZ, GOODMAN &, LANGER & CHICK, PC, 767 THIRD AVENUE, 25TH FLOOR, NEW YORK, NY, 10017-2023, US

(21) Appl. No.: 09/827,612

(22) Filed: Apr. 5, 2001

(30) Foreign Application Priority Data
Jul. 27, 2000 (JP) 2000-226643

(51) Int. Cl. A61G 17/00

(52) U.S. Cl. 27/1

(57) ABSTRACT

A cinerary container is disclosed. It comprises a square main body of a cinerary container which is made of metal and one face of which is open, a magnet setting part formed on an inner wall side face of the cinerary container main body and a lid body for closing the open face of the cinerary container main body. A magnet of the magnet setting part is adapted to attract the lid body and affix a part of a plastic-made bag body which contains ashes and bones.

### BACKGROUND OF THE INVENTION

### FIELD OF THE INVENTION

This invention relates to a cinerary container and more particularly to a cinerary container which receives therein ashes of remains and a projection part (Adam's apple or throat bone) of a thyroid cartilage located at an intermediate part of a human throat and which is then placed on a cinerary altar.

Although it is customary here in Japan to bury the remains of a dead person, which remain after a dead body is cremated, in a graveyard, other cases are increasing for religious reasons or other reasons such as personal belief, in which ashes are scattered in sea, etc. Should related laws be established, the number of other cases would be more increased.

Moreover, the number of cinerary altars is increased in a cemetery and a temple reflecting the shortage of a graveyard. In view of the problem of space, the conventional cinerary urn is required to be miniaturized and an extra space is required to be eliminated. Moreover, due to demographic change, the permanent memorial service is increased and tombs for persons who died leaving no relatives are also increased. Thus, proper processing of ashes and bones is rapidly required.

The present invention has been accomplished in view of the above situation.

### SUMMARY OF THE INVENTION

It is, therefore, an object of the present invention to provide a cinerary container, which is capable of solving the above-mentioned problems inherent in the conventional devices, in which a space necessary for setting (or placing) the cinerary container can be reduced, which can withstand against rot and offensive smell, which can properly cope with quakes, thereby preventing scattering of ashes and bones, in which a bag containing ashes and bones can be prevented from escaping from the container main body by quakes, and which is especially excellent for use in a cinerary altar.

In order to achieve the above object, there is provided a cinerary container comprising a square main body of a cinerary container which is made of metal and one face of which is open, a magnet setting part formed on an inner wall side face of the cinerary container main body and a lid body for closing the open face of the cinerary container main body, a magnet of the magnet setting part being adapted to attract the lid body and affix a part of a plastic-made bag body which contains ashes and bones. The container is preferably totally subjected to antibacterial and anti-smell treatment. The cinerary container may further comprise a bottom plate body corresponding to the lid body. Preferably, the cinerary container has an excitation metal on a part of the plastic-made bag body. It may also has magnetic powder on an opening chuck portion of the plastic-made bag body. It is also preferred that the cinerary container further comprises an oscillation preventive magnet for preventing oscillation of the container body.

By virtue of the above-mentioned construction, the cinerary container according to the present invention can be subjected to recycle use and the containers can be placed in more intimately adjacent relation with respect to one another, thus enabling to meet with the requirement for space saving. In addition, closability can be obtained without sacrificing easy detachability of the lid body, the ashes and Adam's apple contained in the bag body are held stable even against quakes, and the bag body is prevented from escaping from the container main body by quakes.

### BRIEF DESCRIPTION OF THE DRAWINGS

FIG. 1 is a side view of a cinerary container according to one preferred embodiment of the present invention;

FIG. 2 is a plan view of the same;

FIG. 3 is a front sectional view of the same;

FIG. 4 is a front view in which a name plate is detached and brought away from a lid body;

FIG. 5 is a partly perspective view showing a setting state of a magnet;

FIG. 6 is a perspective view in which the name plate is detached and brought away from the lid body; and

FIG. 7 is a partly perspective view showing a setting state of the magnet.

### DETAILED DESCRIPTION OF THE EMBODIMENT

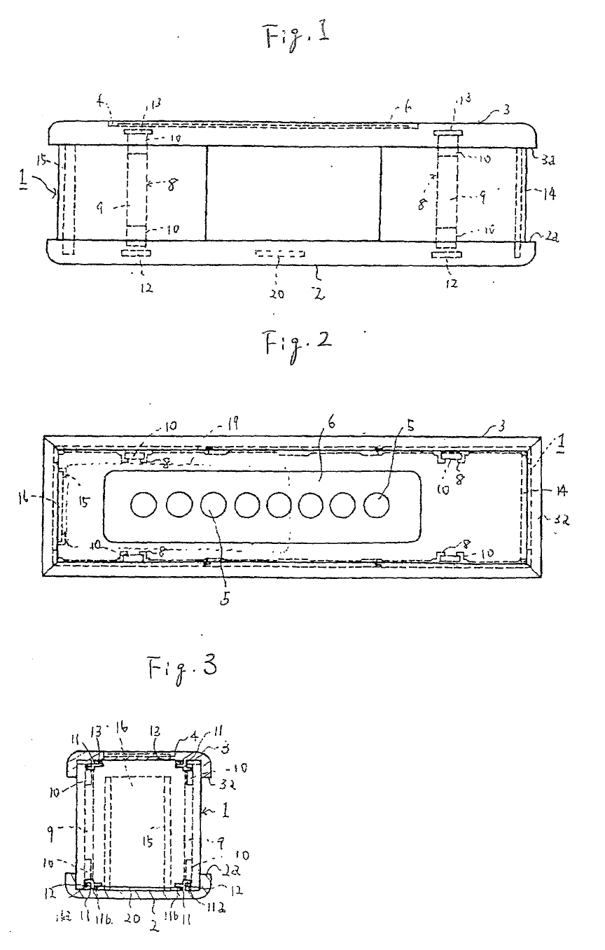

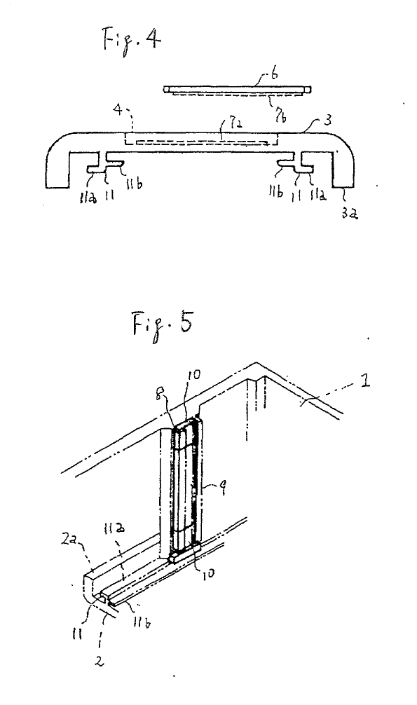

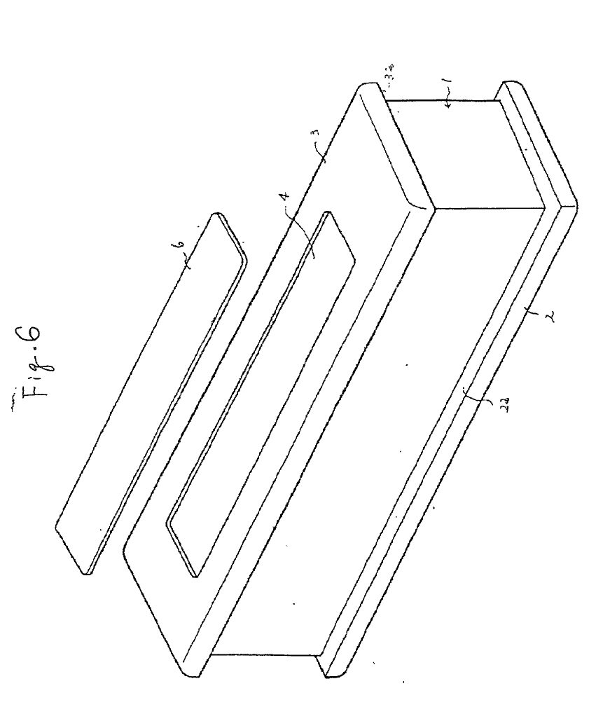

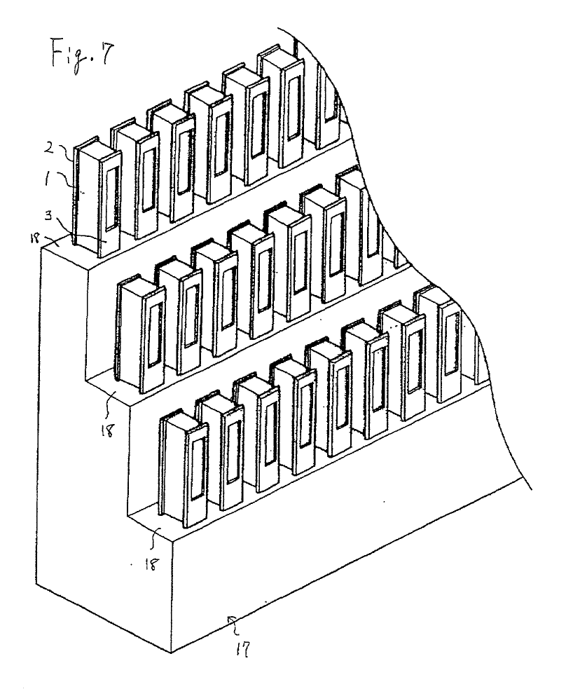

One preferred embodiment of the present invention will now be described with reference to the accompanying drawings. FIG. 1 is a side view of a cinerary container according to one preferred embodiment of the present invention, FIG. 2 is a plan view of the same, FIG. 3 is a front sectional view of the same, FIG. 4 is a front view in which a name plate is detached and brought away from a lid body, FIG. 5 is a partly perspective view showing a setting state of a magnet, FIG. 6 is a perspective view in which the name plate is detached and brought away from the lid body, and FIG. 7 is a partly perspective view showing a setting state of the magnet.

In those Figures, reference numeral 1 denotes a cinerary container main body. This cinerary container main body 1 is made of excitation metal such as steel into a rectangular configuration which is open at least at an upper face thereof. This cinerary container main body 1 including a lid body as later described is subjected to antibacterial and anti-smell treatment by techniques known per se. It should noted that although the cinerary container main body 1 has a rectangular configuration in this embodiment, the present invention is not limited to this. It may have a conventional urn-like configuration.

The cinerary container main body 1 is provided at a bottom face thereof with a bottom plate 2 which has flange portion 2a at a peripheral edge part of the cinerary container main body 1.

On the other hand, the cinerary container main body 1 is detachably attached at an upper face opening thereof with a lid body 3 which has a same configuration as the bottom plate 2 and which likewise has a flange portion 3 at the peripheral edge of the cinerary container main body 1.

A flat recess hole 4 is formed in a top face of the lid body 3 such that the flat concave hole 4 is offset to one side. A name plate 6, which is made of brass, with letters 5 such as a posthumous buddhist name indicated on an outer face thereof is fixedly fitted to the flat concave hole 4. The name plate 6 is fixedly fitted to the flat concave hole 4 by using magnetic sheets 7a, 7b in the flat concave hole 4 and on a rear face of the name plate 6 through a double face adhesive tape, for example. By doing so, the name plate 6 is prevented from dropping and the cinerary container can easily be used at the time of recycle use as resources.

Two pairs of magnet setting parts 8 are formed in opposing relation with each other on an inner wall face of the cinerary container main body 1 along a longitudinal direction of the main body 1. The magnet setting parts 8 are formed in a vertical direction with their L-shaped angles in section held in opposing relation.

An aluminum plate 9 is fitted to an intermediate part of each of the magnet setting parts 8, and plate-like magnets 10 are fitted to upper and lower parts of the aluminum plate 9.

Rail-like magnet attachment parts 11 are formed on inner faces of the bottom plate 2 and the lid body 3 in such a manner as to correspond to the magnet setting parts 8. Each magnet attachment part 11 is comprised of an angle 11a having an L-shaped configuration in section and a projection piece lib projecting inward from the angle 11a.

In the magnet attachment part 11, for example, of the bottom plate 2, a rod-like magnet 12 is inserted at a lower part of the angle 11a such that the rod-like magnet 12 is linearly confronted with the plate-like magnet 10 through a bent part of the angle 11a. Owing to this arrangement, the bottom plate 2 is firmly attracted to the cinerary container body main 1 by powerful magnetic force.

In the magnet attachment part 11, for example, of the lid body 3, a magnet 13 is retained on the projection piece 11b side so that the lid body 11b is attracted to the cinerary container body 1 from the projection piece 11b through the angle 11a. By doing so, the lid body 3 can be detachably attached to the cinerary container main body 1 by weak force compared with the case of the bottom plate 2.

In the case where the cinerary container main body 1 is placed in an erected manner as later described, a plate-like magnet 14 is disposed over an entire lower face, i.e., entire inner face remote from the name plate 6 in a short direction. On the inner side of an upper face side of the cinerary container main body 1, a magnet setting part 15, which is composed of opposing angles, is formed and there is also provided thereon a plate-like magnet 16 for suspending a bag body 19 which is adapted to contain ashes and bones and which is made of a strong raw material hardly pierced nor broken by the bones.

In the illustration, reference numeral 20 denotes a belt-like magnet for restraining oscillation of the bag body 19. This belt-like magnet 20 is disposed on the bottom plate 2 side of the cinerary container main body 1, i.e., interior of the cinerary container main body 1 which is located at the back side when the main body 1 is in the erected state. It should be noted that although the oscillation preventing magnet 20 is in the form of a belt in this embodiment, the present invention is not limited to this. For example, it may, of course, be in the form of a dot or broken line.

In this embodiment, an Adam's apple and ashes are contained in the bag body 19 and subjected to vacuum treatment. The bag body 19 is provided at a part thereof with an excitation metal belt or at an opening chuck part thereof with magnetic powder. The bag body 19 is suspended by attracting its magnetic body part with the plate-like magnet 16 and the other part of the bag body 19 is attracted by the oscillation preventing magnet 20. By doing so, the bag body 19 is attracted and retained in a stable manner by the oscillation preventing magnet 20.

In this way, the cinerary container main body 1 containing the bag body 19 which contains ashes and bones is, as shown in FIG. 7, placed in its erected state on a shelf part 18 of a cinerary alter 17. By laying a magnetic metal plate or the like at least on the face of the shelf part 18 at that time, the cinerary container main body 1 can be attracted under the effect of the plate-like magnet 14.

The cinerary container according to the present invention is constituted and used in the manner as mentioned above. Accordingly, a space necessary for setting (or placing) can be reduced compared with the prior art, thus enabling to set (or place) an increased number of cinerary containers to that extent. Moreover, because metal is used as its raw material, recycle use can be made possible. Moreover, by virtue of its construction, the cinerary container according to the present invention can properly cope with quakes. In particular, it never occurs that bones contained in the plastic bag body which is contained in the cinerary container main body are collided with the inner wall face of the cinerary container main body and rollingly moved within the main body.

Additional advantages and modifications will readily occurs to those skilled in the art. Therefore, the invention in its broader aspects is not limited to the specific details and representative embodiments shown and described herein. Accordingly, various modifications may be made without departing from the spirit or scope of the general inventive concept as defined by the appended claims.

What is claimed is:

1. A cinerary container comprising a square main body of a cinerary container which is made of metal and one face of which is open, a magnet setting part formed on an inner wall side face of said cinerary container main body and a lid body for closing said open face of said cinerary container main body, a magnet of said magnet setting part being adapted to attract said lid body and affix a part of a plastic-made bag body which contains ashes and bones.

2. A cinerary container according to claim 1, wherein said container is totally subjected to antibacterial and anti-smell treatment.

3. A cinerary container according to claim 1 or 2, which further comprises a bottom plate body corresponding to said lid body.

4. A cinerary container according to claim 1 or 2, which has an excitation metal on a part of said plastic-made bag body.

5. A cinerary container according to claim 4, which has magnetic powder on an opening chuck portion of said plastic-made bag body.

6. A cinerary container according to claim 1, which comprises a cinerary container main body which is partly open and which has a lid body for closing said opening, and a magnet setting part formed on an inner wall face of said cinerary container main body and having a magnet arranged on said magnet setting part, said magnet of said magnet setting part being adapted to attract said lid body and affix a part of a bag body which contains ashes and bones, wherein at least a deep face of the inner wall face of said cinerary container main body is provided with an oscillation preventive magnet which is adapted to affix an intermediate or lower part of said bag body.

7. A cinerary container according to claim 6, wherein said oscillation preventive magnet is in the form of a belt.

8. A cinerary container according to claim 6, wherein said oscillation preventive magnet is in the form of a dot.

9. A cinerary container according to claim 6, which is totally rectangular and which has a name plate on a front face thereof.
